(19) United States
(12) Patent Application Publication
(10) Pub. No.: US 2006/0225563 A1
(43) Pub. Date: Oct. 12, 2006

(54) Adjuster for relative position between actuators and objects, automatic player equipped therewith and musical instrument having the same

(75) Inventor: Yasuhiko Ohba, Shizuoka-ken (JP)

Correspondence Address: HARNESS, DICKEY & PIERCE, P.L.C., P.O. BOX 828, BLOOMFIELD HILLS, MI, 48303, US

(73) Assignee: Yamaha Corporation, Hamamatsu-shi (JP)

(21) Appl. No.: 11/376,674

(22) Filed: Mar. 15, 2006

(30) Foreign Application Priority Data
Mar. 23, 2005 (JP) 2005-084532

(51) Int. Cl. G10H 1/32; G10H 3/00

(52) U.S. Cl. 84/744

(57) ABSTRACT

An automatic player piano is a combination between a piano and an electric system, and key actuators, which are provided under the black and white keys of the piano, is responsive to a driving signal so as selectively give rise to motion of the black and white keys without any fingering of a human player; an adjuster is provided in association with the key actuators so as to aid an adjusting work on the key actuators, and includes key sensors and a controller; when a worker requests the controller to assist him in the adjusting work, the controller checks the key position signals to see whether or not the key actuators are found at proper relative positions to the black and white keys, and informs the worker of the deviation from the proper relative position so that the worker easily adjusts the key actuators at the proper relative positions.

### FIELD OF THE INVENTION

This invention relates to an automatic player for a musical instrument and, more particularly, to an adjuster for actuators, an automatic player having the actuators provided for component parts such as, for example, keys of a musical instrument.

### DESCRIPTION OF THE RELATED ART

An automatic player piano is a typical example of the automatic player musical instrument. The automatic player piano is broken down into an acoustic piano and an automatic player. The automatic player sequentially gives rise to the key motion by means of the solenoid-operated key actuators so as to perform a piece of music without fingering of a human player. The black and white keys are provided over a key bed, and pitch up and down with respect to the balance rail on the key bed. On the other hand, the solenoid-operated key actuators are provided under the rear portions of the black and white keys, and are supported by the key bed. While the automatic player is performing a music passage, the solenoid-operated key actuators are selectively energized with driving signals, and project their plungers from and retract them into the yoke so as to give rise to the key motion through the plunger motion. Thus, the force is transmitted from the plungers to the black and white keys.

Although the solenoid-operated key actuators and the black and white keys are incorporated in the automatic player and the acoustic piano, respectively, the solenoid-operated key actuators are exactly expected to collaborate with the black and white keys to perform a piece of music. If the distance between the solenoid-operated key actuators and the associated black and white keys is too long, the plungers reach the upper dead points before the escape of the jacks from the hammers, and the strings are not struck with the hammers. In other words, any acoustic piano tone is not produced. If, on the other hand, the distance is too short, the black and white keys reach the end position before the plungers reach the upper dead points, and are liable to damage the associated black and white keys. Thus, the solenoid-operated key actuators are to be accurately located at their target positions with respect to the black and white keys.

Although the black and white keys and solenoid-operated key actuators are supported by the key bed as described hereinbefore, the solenoid-operated key actuators are merely correlated with the black and white keys through the key bed. Since there is not any guarantee that the black and white keys and solenoid-operated key actuators are just located at the target positions on the key bed, it is rate that the relative position between the solenoid-operated key actuators and the black and white keys is optimum for the cooperation. For this reason, an adjuster is provided for the solenoid-operated key actuators.

The prior art adjuster is disclosed in Japanese Patent Application laid-open No. Hei 9-237082. The prior art adjuster disclosed in the Japanese Patent Application laid-open is of the type mechanically changing the distance between the array of solenoid-operated key actuators and the key bed. In detail, the solenoid-operated key actuators are mounted on the bracket, and the bracket is hung from another bracket secured to the key bed. Both brackets are connected to one another by means of bolts. When a worker drives the bolts, the distance between the key bed and the array of solenoid-operated key actuators is varied. If the distance between the black and white keys and the plungers is too long, the worker shortens the distance between the array of solenoid-operated key actuators and the key bed so that the plungers get close to the black and white keys. If, on the other hand, the distance is too short, the worker spaces the array of solenoid-operated key actuators from the key bed by means of the bolts. Thus, the brackets and bolts form in combination the prior art adjuster.

However, a problem is encountered in the adjusting work in that the worker consumes long time for the adjustment. In detail, the worker firstly fixes the array of solenoid-operated key actuators to a certain position, which is seemed to be optimum through his or her experience, and energizes the solenoid-operated key actuators. Then, the solenoid-operated key actuators project their plungers, and give rise to the key motion. The worker observes the key motion, and decides whether or not the array of solenoid-operated key actuators is located at proper positions with respect to the black and white keys. If the answer is negative, the worker drives the bolts, and varies the distance between the array of solenoid-operated key actuators and the black and white keys. After the adjustment, the worker energizes the solenoid-operated key actuators, again, and observes the key motion to see whether or not the adjusting work is further required for the array of solenoid-operated key actuators. Thus, the worker seeks the optimum position through the trial and error method. This is the reason why the worker consumes the long time period.

### SUMMARY OF THE INVENTION

It is therefore an important object of the present invention to provide an adjuster, which makes an adjusting work easy and speedy.

It is also an important object of the present invention to provide an automatic player, in which the adjuster is incorporated.

It is another important object of the present invention to provide a musical instrument, which is equipped with the automatic player.

In accordance with one aspect of the present invention, there is provided an adjuster for adjusting actuators to respective relative positions with respect to component parts of a musical instrument comprising sensors producing a status signal representative of current status of the component parts, and a controller connected to the sensors and producing an information signal representative of deviation between the current status and the relative positions so as to aid an adjusting work on the actuators.

In accordance with another object of the present invention, there is provide an automatic player for automatically producing music sound through a musical instrument comprising actuators proved in association with component parts of the musical instrument and responsive to a driving signal so as selectively to give rise to motion of the component parts for producing the music sound, and an adjuster for adjusting the actuators to respective relative positions with respect to the component parts and including sensors producing a status signal representative of current status of the component parts and a controller connected to the actuators for supplying the driving signal thereto and to the sensors for receiving the status signal and producing an information signal representative of deviation between the current status and the relative positions so as to aid an adjusting work on the actuators.

In accordance with yet another object of the present invention, there is provided a musical instrument for producing music sound comprising a sound generating mechanism including component parts selectively actuated for producing the music sound, actuators proved in association with the component parts of the musical instrument and responsive to a driving signal so as selectively to give rise to motion of the component parts, and an adjuster for adjusting the actuators to respective relative positions with respect to the component parts and including sensors producing a status signal representative of current status of the component parts and a controller connected to the actuators for supplying the driving signal thereto and to the sensors for receiving the status signal and producing an information signal representative of deviation between the current status and the relative positions so as to aid an adjusting work on the actuators.

### BRIEF DESCRIPTION OF THE DRAWINGS

The features and advantages of the adjuster, automatic player and musical instrument will be more clearly understood from the following description taken in conjunction with the accompanying drawings, in which

FIG. 1 is a cross sectional side view showing the structure of an automatic player piano embodying the present invention,

FIG. 2 is a plane view showing solenoid-operated key actuators held in an actuator holder,

FIG. 3 is a block diagram showing the system configuration of a controller incorporated in the automatic player piano,

FIG. 4A is a flowchart showing a job sequence carried out by a human worker in an adjusting work,

FIG. 4B is a flowchart showing a job sequence accomplished by the controller in the adjusting work,

FIG. 4C is a view showing visual images produced on a display window,

FIG. 5A is a flowchart showing a job sequence carried out for an adjusting work on another automatic player piano,

FIG. 5B is a flowchart showing a job sequence accomplished by a controller incorporated in the automatic player piano,

FIG. 5C is a view showing visual images produced on a display window of the controller incorporated in the automatic player piano,

FIG. 6 is a cross sectional side view showing yet another automatic player piano according to the present invention,

FIG. 7 is a block diagram showing the system configuration of a controller incorporated in the automatic player piano,

FIG. 8A is a flowchart showing a job sequence carried out for an adjusting work on yet another automatic player piano,

FIG. 8B is a flowchart showing a job sequence accomplished by a controller incorporated in the automatic player piano,

FIG. 9A is a flowchart showing a job sequence carried out for an adjusting work on still another automatic player piano,

FIG. 9B is a flowchart showing a job sequence accomplished by a controller incorporated in the automatic player piano,

FIG. 10 is a view showing a visual image produced on a display window for indicating relative position between key actuators and keys, and

FIG. 11 is a cross sectional side view showing a portable display panel used in yet another automatic player piano.

### DESCRIPTION OF THE PREFERRED EMBODIMENTS

A musical instrument embodying the present invention largely comprises a sound generating mechanism, actuators and an adjuster. The actuators and adjuster may form an automatic player physically separated from a musical instrument, and the adjuster may be offered to workers or users independently of the musical instrument and actuators.

The sound generating mechanism includes a certain sort of component parts and other sorts of component parts. The component parts of the certain sort are connected to the component parts of the other sorts for forming plural transmission lines, and the plural transmission lines are selectively actuated by a human player for producing music sound. Thus, the sound generating mechanism is the essential part of the musical instrument.

The actuators are provided in association with the component parts of the certain sort, and are connected to a controller, which is shared with the adjuster. When a user instructs the controller to reenact a performance on the musical instrument, the controller starts selectively to supply a driving signal to the actuators. The driving signal makes the actuators selectively give rise to motion of the component parts of the certain sort so that the sound generating mechanism produces the music sound without any manipulation of a human player. Thus, the actuators actuate the transmission lines through the motion of the component parts of the certain sort. This means that the actuators are to be located at optimum or proper relative positions with respect to the component parts of the certain sort.

In order to locate the actuators at the proper relative positions, the adjuster is provided in association with the actuators. The adjuster includes sensors and the controller, which is shared with the actuators. Of course, a controller may be provided in the adjuster separately from the controller for the actuators. The sensors monitor the component parts, and produce a status signal representative of current status of the component parts. The status signal is supplied to the controller.

The controller processes pieces of status data representative of the current status, and determines deviation between the current status and the proper relative positions. If one of the actuators is found at the proper relative position, any deviation does not take place. On the other hand, when the status signal is indicative of another actuator which left the proper relative position, the controller determines that the deviation takes place. The controller produces an information signal representative of the deviation.

The information signal may notify a human worker of the requirement of a further adjusting work so that the human worker manually adjusts the actuators to the proper relative position. Otherwise, the information signal may be supplied to a suitable motor or an actuator. Otherwise, the motor or actuator automatically adjusts the actuators to the proper relative positions without the work carried by a human worker.

As will be understood from the foregoing description, the adjuster assists the human worker in the adjusting work, and makes the adjusting work easy and speedy.

In the following description, term “front” is indicative of a position closer to a player, who is seated himself or herself before a musical instrument, than a position modified with term “rear”. Term “fore-and-aft” is indicative of a direction passing through a front point and a corresponding rear point, and a lateral direction crosses the fore-and-aft direction at right angle. An up-and-down direction is normal to a plane defined by the fore-and-aft direction and lateral direction.

### First Embodiment

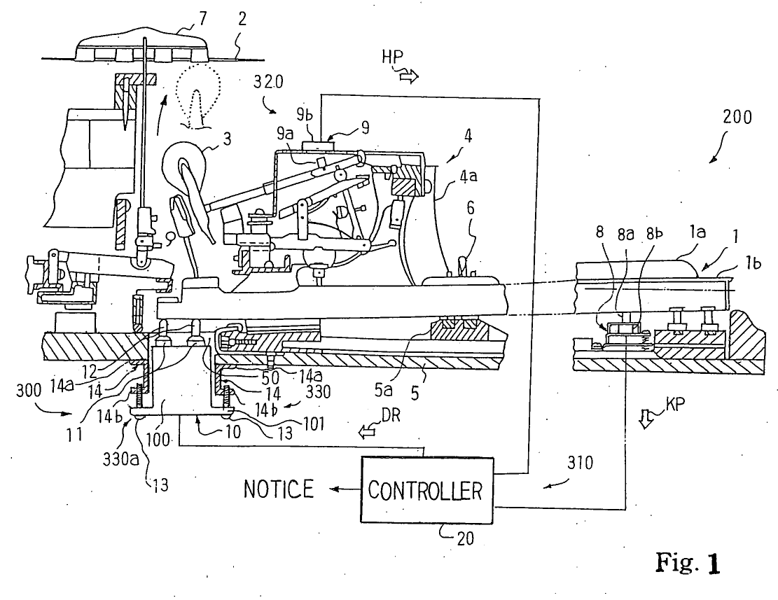

Referring first to FIG. 1 of the drawings, an automatic player piano embodying the present invention largely comprises an acoustic piano 200 and an electronic system 300. In this instance, the acoustic piano 200 is a grand piano. The electronic system 300 is installed inside the acoustic piano 200, and serves as an automatic player 310, a recorder 320 and an adjuster 330. The automatic player 310 performs a music passage on the acoustic piano 200 without any fingering of a human player, and the recorder 320 converts a performance on the acoustic piano to pieces of music data. The automatic player 310 and recorder 320 are well known to persons skilled in the art, and, for this reason, no further description is hereinafter incorporated. The adjuster 330 determines current key positions, and informs a human worker of the current key positions. Thus, the adjuster 330 collaborates with the human worker in the adjusting work. The electronic system 300 has various system components, and several system components are shared among the automatic player 310, recorder 320 and adjuster 330 as will be hereinlater described in detail.

Acoustic Piano

The acoustic piano 200 includes a keyboard 1, strings 2, hammers 3 and action units 4. Black keys 1a and white keys 1b are incorporated in the keyboard 1, which is mounted on a key bed 5, and extend in parallel to the fore-and-aft direction. In this instance, eighty-eight black and white keys 1a/1b are incorporated in the keyboard 1. The key bed 5 defines the lower extent of a piano cabinet, and is connected to upper ends of legs (not shown).

Balance pins 6 project from a balance rail 5a, and are provided as fulcrums for key motion. For this reason, the black keys 1a and white keys 1b pitch up and down over the key bed 5. The hammers 3 and action units 4 are provided over the rear portions of the black keys 1a and the rear portions of the white keys 1b, and the strings 2 are stretched over the hammers 3.

The rear portions of black and white keys 1a and 1b are held in contact with the action units 4 so that the total weight of hammers 3 and action units 4 are exerted on the rear portions of the associated black and white keys 1a and 1b. As a result, the front portions of the black and white keys 1a and 1b are spaced from the key bed 5 on the condition that any other force is not exerted on the black and white keys 1a and 1b, and the black and white keys 1a and 1b are staying at respective rest positions. The black and white keys 1a and 1b at the rest positions are drawn by solid lines in FIG. 1, and the keystroke at the rest positions is zero millimeter long.

While a player is exerting force on the front portions of black and white keys 1a and 1b, the front portions are sinking toward end positions, and the rear portions of the black and white keys 1a and 1b lift the associated action units 4. Jacks, which form parts of the action units 4, escape from the hammers, and kick the associated hammers 3. Then, the hammers 3 start free rotation, and are brought into collision with the strings 2 at the end of the free rotation. The hammers 3 give rise to vibrations of the strings 2, and the acoustic piano tones are generated through the vibrations of the strings 2. Dots-and-dash line is indicative of the upper surface of the white key 1b at the end position, and the hammer 3 at the end position is drawn by broken lines.

The acoustic piano 200 further includes dampers 7. The dampers 7 are provided over the rear end portions of the black and white keys 1a and 1b, and are spaced from and brought into contact with the associated strings 2. When the black and white keys 1a and 1b are found at the rest positions, the dampers 7 are held in contact with the strings 2, and prevent the associated strings 2 from resonance with the vibrations of another string 2. A player is assumed to depress the front portion of one of the black and white keys 1a and 1b. The rear portion of the black/white key 1a/1b is brought into contact with the damper lever of the associated damper 7 on the way to the end position. The black/white key 1a/1b proceeds to the end position, and the rear portion of black/white key 1a/1b pushes the damper 7 upwardly. As a result, the damper 7 is spaced from the associated string 2, and the string 2 gets ready to vibrate.

A player is assumed to instruct the electronic system 300 to record his or her performance on the acoustic piano 200. While the player is performing a music passage, he or she selectively depresses and releases the black and white keys 1a and 1b. The depressed keys 1a/1b actuate the associated action units 4 so as to drive the hammers 3 for the rotation, and the hammers 3 give rise to the vibrations of the associated strings 2 at the end of the rotation for generating the acoustic piano tones. The player releases the depressed keys 1a/1b after the generation of the acoustic piano tones. The released keys 1a/1b start to return to the rest positions, and the dampers 7 are brought into contact with the vibrating strings 2 on the way to the rest positions. Thus, the acoustic piano tones are decayed.

The recorder 320 monitors the black/white keys 1a/1b and hammers 3, and determines the key number of the depressed/released keys 1a/1b, hammer velocity immediately before the collision with the strings 2, a time at which the acoustic tones are produced and a time at which the acoustic tones are decayed. The recorder 320 stores the key number, hammer velocity, time to produce the acoustic tones and time at which the acoustic tones are decayed, i.e., pieces of music data in music data codes. Thus, the recorder 320 produces a set of music data codes expressing the performance on the acoustic piano 200.

Electronic System

The electronic system 300 includes key sensors 8, hammer sensors 9, solenoid-operated key actuators 10 and a controller 20. The key sensors 8, hammer sensors 9 and solenoid-operated key actuators 10 are connected to the controller 20. The key sensors 8, hammer sensors 9 and controller 20 form in combination the recorder 320, and the key sensors 8, solenoid-operated key actuators 10 and controller 20 constitute the automatic player 310. The adjuster 330 will be hereinlater described in detail.

The key sensors 8 are of the type converting the keystroke to the amount of light. Each of the key sensors 8 has an optical modulator 8a and a pair of optical sensor head 8b. The optical modulator 8a is attached to the lower surface of the associated black/white key 1a/1b, and travels on a predetermined trajectory together with the associated black/white key 1a/1b. On the other hand, the pair of optical sensor head 8b is secured to the key bed 5, and throws an optical beam across the predetermined trajectory. When the black/white key 1a/1b stays at the rest position, the optical modulator 8a makes the amount of light maximized. The amount of light is gradually reduced during the travel from the rest position to the end position. The modulated light is converted to electric current, and a key position signal KP, which represents the keystroke from the rest position, is produced from the electric current.

The hammer sensors 9 are also of the type converting hammer stroke to the amount of light. Each of the hammer sensors 9 has an optical modulator 9a and a pair of optical sensor head 9b. The optical modulator 9a is attached to the hammer shank of the associated hammer 3, and travels on a predetermined trajectory together with the associated hammer 3. On the other hand, the pair of optical sensor head 9b is supported by action brackets 4a, and throws an optical beam across the predetermined trajectory. When the hammer 3 is found at the rest position, the optical modulator 9a makes the amount of light maximized. The amount of light is gradually reduced during the travel from the rest position to the end position where the hammer 3 is brought into collision with the string 2. The modulated light is converted to electric current, and a hammer position signal HP, which represents the hammer stroke from the rest position, is produced from the electric current.

The key position signals KP and hammer position signals. HP are supplied from the key sensors 8 and hammer sensors 9 to the controller 20. While the electronic system 300 is serving as the recorder 320, the controller 20 determines the key number and time at which the acoustic piano tone is decayed on the basis of the key position signals KP, and the velocity and time at which the acoustic piano tone is produced on the basis of the hammer position signals HP.

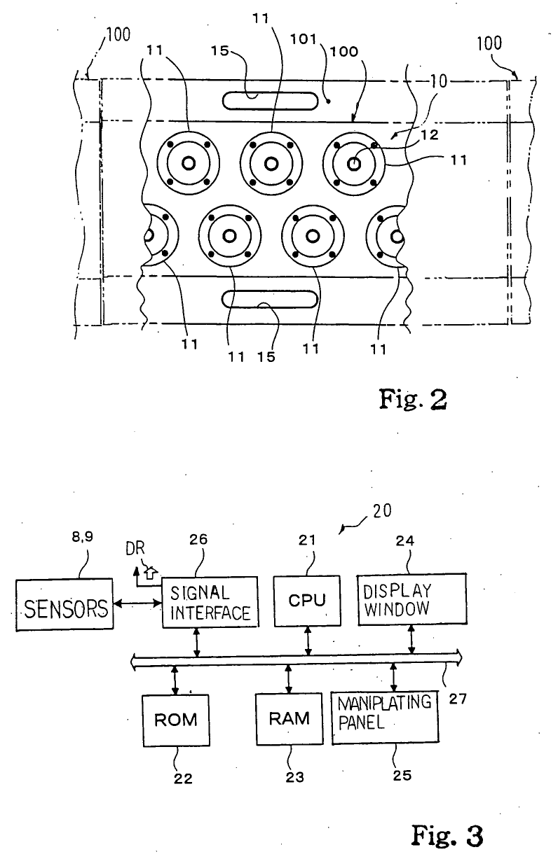

The solenoid-operated key actuators 10 are arranged in a staggered fashion in the lateral direction as shown in FIG. 2, and are supported by the key bed 5. Since each of the black and white keys 1a/1b is driven by one of the solenoid-operated key actuators 10, eighty-eight solenoid-operated key actuators 10 form the array under the rear portions of the black and white keys 1a/1b.

Each of the solenoid-operated key actuators 10 includes a solenoid 11 and a plunger 12. The solenoids 11 are directed in the up-and-down direction, and the plungers 12 are projectable from and retractable into the associated solenoids 11. Though not shown in FIGS. 1 and 2, a suitable stopper is provided inside the solenoid-operated key actuator 10, and prevents the plunger 12 from dropping out from the associated solenoid 11. The controller 20 is connected to the solenoids 11 in parallel so that a driving signal DR is selectively supplied from the controller 20 to the solenoids 11. A pulse width modulator is available for the regulation of the magnitude. While the driving signal DR is flowing through the solenoid 11, a magnetic field is created, and exerts magnetic force on the plunger 12 so that the plunger 12 upwardly projects from the solenoid 11. The array of solenoid-operated key actuators 10 may be associated with a current driver, which is responsive to the driving signal DR. The current driver may unit with the array of solenoid-operated key actuators 10.

Turning back to FIG. 1, a slot 50 is formed in the key bed 5 under the rear portions of the black and white keys 1a and 1b. The solenoid-operated key actuators 10 are located at proper positions just under the rear portions of the associated black and white keys 1a and 1b, and are hung from the key bed 5. The solenoid-operated key actuators 10 pass through the slot 50, and the plungers 12, which are retracted in the solenoids 1, have top surfaces in the proximity of the lower surfaces of the black and white keys 1a/1b at the rest positions.

A user is assumed to instruct the automatic player 310 to reenacts a performance. A set of music data code, which expresses the performance, is loaded into the controller 20, and the controller 20 starts to measure the lapse of time. The controller 20 searches the set of music data codes for a note-on event and a note-off event to be presently realized.

When the controller 20 finds a music data code expressing the note-on event for a black/white key 1a/1b, the controller 20 determines a reference forward key trajectory, which is equivalent to a series of values of target key position, and supplies the driving signal DR to the solenoid-operated key actuator 10 associated with the black/white key 1a/1b at a time earlier than the time to produce the acoustic piano tone by a certain time period. The plunger 12 upwardly pushes the rear portion of the black/white key 1a/1b so that the black/white key 1a/1b starts to travel on the reference forward key trajectory.

The key sensor 8 reports the current key position through the key position signal KP to the controller 20, and the controller 20 inspects a pieces of motion data expressed by the key position signal KP to see whether or not the black/white key 1a/1b exactly travels on the reference forward key trajectory. If the current key position is equal to the target key position, the controller 20 keeps the driving signal DR at the current magnitude. However, if not, the controller 20 regulates the driving signal DR to a proper magnitude, and forces the black/white key 1a/1b exactly to travel on the reference forward key trajectory.

When the controller 20 finds the note-off event for a black/white key 1a/1b, the controller 20 determines a reference backward key trajectory, and forces the black/white key 1a/1b to travel on the reference backward key trajectory in a similar manner to the black/white key 1a/1b driven for the note-on event. The black/white key 1a/1b permits the damper 7 to be brought into contact with the vibrating string 2 on the way to the rest position so that the acoustic piano tone is decayed at the time expressed by the music data code.

The controller 20 repeats the above-described data processing for all the black and white keys 1a/1b to be depressed and to be released, and the acoustic piano tones are sequentially produced and decayed. Thus, the performance is reproduced by the automatic player 310 without any fingering of a human player.

The plungers 12, which are retracted in the associated solenoids 11, have respective top surfaces around the lower surfaces of the rear portions of the associated black and white keys 1a/1b at the rest positions. The gap between the top surfaces and the lower surfaces of the black and white keys 1a/1b is to be as narrow as possible. If the solenoid-operated key actuators 10 are too low with respect to the key bed 5, the top surfaces are widely spaced from the lower surfaces, and the solenoid-operated key actuators 10 can not move the associated black and white keys 1a/1b to the end positions. If the gap is too wide, the jacks do not escape from the hammer 3, and any acoustic piano tone is not generated. On the other hand, if the solenoid-operated key actuators 10 are too high with respect to the key bed 5, the rear portions of the associated black and white keys 1a/1b are pushed with the plungers 12, which are retracted in the solenoids 11, so that the black and white keys 1a/1b are always found to be spaced from the rest positions. Thus, the relative position between the solenoid-operated key actuators 10 and the key bed 5 is to be optimized.

The adjuster 330 is provided for the solenoid-operated key actuators 10. The adjuster 330 includes the key sensors 8, controller 20 and an adjusting mechanism 330a. The structure of the adjusting mechanism 330 is firstly described, and description on the function of the controller 20 follows.

The adjusting mechanism 330a includes plural actuator holders 100, bolts 13 and a pair of brackets 14. The solenoid-operated key actuators 10 are grouped, and the plural groups of solenoid-operated key actuators 10 are respectively assigned to plural registers. In this instance, the black and white keys 1a/1b are divided into a higher register, a middle register and a lower register, i.e., three registers so that three actuator holders 100 are provided for the black and white keys 1a/1b. The pair of brackets 14 is shared among the plural actuator holders 100.

Since the actuator holders 100 are similar in structure to one another, one of the actuator holders 100, which the black and white keys 1a/1b of the middle register are assigned to, is hereinafter described in detail. The black and white keys 1a/1b are accommodated in the actuator holder 100, and the actuator holder 100 keeps the solenoid-operated key actuators 10 in the staggered fashion (see FIG. 2). The staggered fashion is desirable, because the large coils 11 are gathered in the narrow area. A pair of flanges 101 is formed in the lower portion of the actuator holder 100, and each of the flanges 101 is formed with elongated holes 15. The elongated holes 15 have a width slightly greater than the diameter of the threaded stems of the bolts 13, and the width of the elongated holes 15 is narrower than the width of the heads of the bolts 13. For this reason, the actuator holder 100 is laterally movable before tightening the bolts 13. When the actuator holder 100 is hung from the key bed 5, one of the flanges 101 is directed in the forward direction, and the other flange 101 is directed in the rearward direction.

The brackets 14 have a channel shape, and an upper flange 14a and a lower flange 14b of each bracket 14 project in parallel. Threaded holes are formed in the lower flanges 14b. The brackets 14 are arranged in the back-to-back fashion, and extend in parallel to the slot 50. One of the brackets 14 is frontward directed, and the upper flange 14a is secured to the front area of the lower surface of the key bed 5 with respect to the slot 50. On the other hand, the other bracket 14 is rearward directed, and the upper flange 14a is secured to the rear area with respect to the slot 50. The brackets 14 are spaced from each other in the fore-and-aft direction, and the distance between the lower flanges 14b is equal to the distance between the flanges 101. For this reason, the lower flanges 14b are respectively connected to the flanges 101 by means of the bolts 13.

The adjusting mechanism 330a is analogous to the prior art adjusting mechanism disclosed in Japanese Patent Application laid-open No. 9-237082 so that the modifications disclosed therein are available for the adjusting mechanism 330a.

When the plungers 12 are spaced from the lower surfaces of the black and white keys 1a/1b, the bolts 13 are driven into the threaded holes in the lower flanges 14b so that the gap between the key bed 5 and the flanges 101 are decreased. On the other hand, if the bolts 13 are driven out from the lower flanges 14b, the gap is increased, and the array of solenoid-operated key actuators 10 is lowered with respect to the rear portions of the black and white keys 1a/1b.

If the plungers 12 are laterally offset from the rear portions of the black and white keys 1a/1b, the bolts are moved in the elongated holes 15. Thus, a human worker manually adjusts the array of solenoid-operated key actuators 10 to not only target height but also to target lateral positions.

Turning to FIG. 3 of the drawings, the controller 20 includes a central processing unit 21, which is abbreviated as “CPU”, a read only memory 22, which is abbreviated as “ROM”, a random access memory 23, which is abbreviated as “RAM”, a display window 24, a manipulating panel 25, a signal interface 26 and a shared bus system 27. The central processing unit 21, read only memory 22, random access memory 23, display window 24, manipulating panel 25 and signal interface 26 are connected to the shared bus system 27 so that the central processing unit 21 communicates with the other system components 22, 23, 24, 25 and 26 through the shared bus system 27. The key sensors 8 and hammer sensors 9 are connected to the signal interface 26, and the driving signal DR is selectively supplied from a pulse width modulator (not shown) to the coils 11.

The central processing unit 21 is the origin of the data processing capability. A computer program runs on the central processing unit 21 so that the central processing unit 21 accomplishes jobs.

Instruction codes and pieces of control data are stored in the read only memory 22. The instruction codes form the computer program. In case where an electrically erasable and programmable read only memory is installed as the read only memory 22, the computer program may be rewritten for the version-up. The computer program includes a main routine program and several sub-routine programs. When the controller 20 is energized, the main routine program starts to run, and initializes the electronic system 300. Upon completion of the initialization, the central processing unit 20 starts to communicate with the manipulating panel 25. One of the subroutine programs is assigned to the recording, and another subroutine program and yet another subroutine program are respectively assigned to the automatic playing and adjusting work. Users and workers give their instructions to the controller 20 through the manipulating panel 25.

When the user requests the controller 20 to record or reenact a performance, the main routine program starts periodically to branch the subroutine program through timer interruptions so that the central processing unit 20 sequentially executes the instruction codes so as to accomplish the jobs described hereinbefore. When a worker requests the controller 20 to assist him or her in the adjusting work, the main routine program also starts to branch the subroutine program for the adjusting work through timer interruption, and the subroutine program for the adjusting work will be hereinlater described in detail.

The random access memory 23 serves as a working memory during the jobs. The central processing unit 21 memorizes pieces of key position data, which are reported through the key position signals KP, pieces of hammer position data, which are reported through the hammer position signals HP, calculation results and pieces of music data, which are stored in the music data codes, in the working memory. Flags, registers and tables are prepared in the random access memory 23, and the central processing unit 20 uses them during the data processing. In case where the computer program is down-loaded from an external source, the computer program is stored in the random access memory 23.

The display window 24 is a man-machine interface. For example, the central processing unit 21 produces visual images of prompt messages, visual images of status messages and visual images of inspection report on the display window. The central processing unit 20 produces the inspection report in the adjusting work so as to assist the worker.

Buttons, switches, keys, indicators are provided on the manipulating panel, and users and workers selectively manipulate the buttons, switches and keys so as to give the instructions to the controller 20. One of the switches is assigned the adjusting work, and a worker manipulates the switch before the adjusting work. Then, the electronic system 300 starts to serve as the adjuster 330.

Analog-to-digital converters and data buffers are incorporated in the signal interface 26. While the electronic system 300 is serving as the automatic player 310 or recorder 320, discrete values on the key position signals KP and discrete values on the hammer position signals HP are periodically converted to digital key position codes and digital hammer position codes, and the digital key position codes and digital hammer position codes are temporarily stored in the data buffers. The central processing unit 20 fetches the digital key position codes/digital hammer position codes from the data buffer, and transfers them to the random access memory 23 so as to memorize the pieces of key position data/pieces of hammer position data.

Though not shown in FIG. 3, a pulse width modulator is further incorporated in the signal interface 26. While the automatic player 310 is reenacting a performance, the central processing unit 21 supplies control codes expressing proper values of a duty ratio to the pulse width modulator, and the pulse width modulator adjusts the driving signal DR to the given values of the duty ratio.

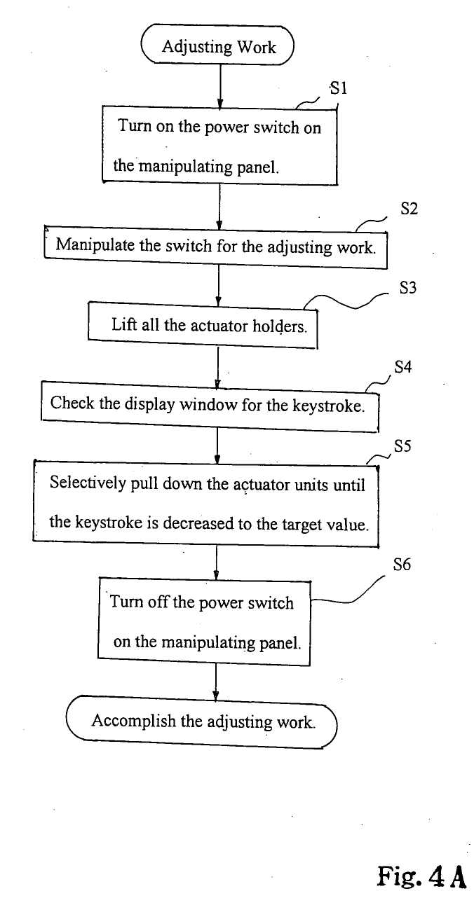

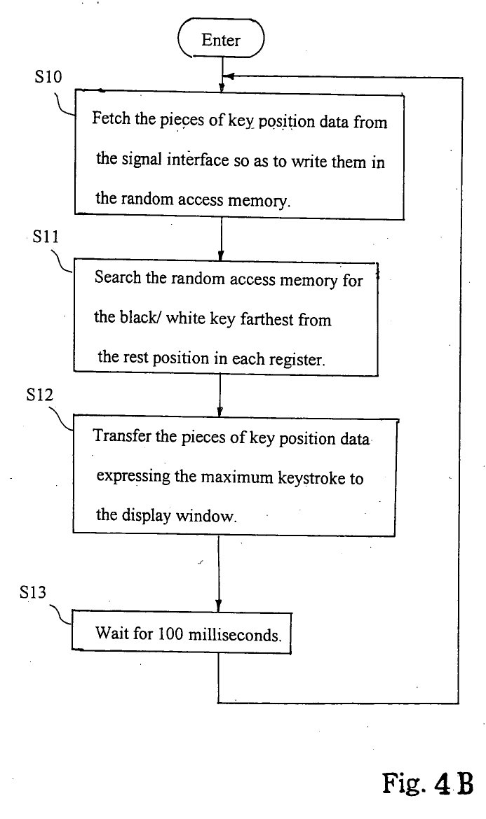

Subsequently, description is made on the adjusting work with reference to FIGS. 4A and 4B. A human worker carries out jobs shown in FIG. 4A, and jobs shown in FIG. 4B are accomplished by the controller 20. In other words, the job sequence shown in FIG. 4A is in parallel to the job sequence shown in FIG. 4B, and the controller 20 assists the human worker in the adjusting work.

When the adjusting work is required for the automatic player piano, a worker turns on the power switch on the manipulating panel 25 as by step S1, and instructs the controller 20 to assist him or her by manipulating the switch assigned the adjusting work as by step S2. Then, the main routine program starts periodically to branch the subroutine program for the adjusting work. The central processing unit 21 intermittently reiterates a loop consisting of steps S10 to S13 in the subroutine program.

The worker drives in all of the bolts 13 so as to decrease the gap between the brackets 14 and the actuator holders 100. Thus, the worker lifts all the actuator holders 100 so as to push the rear portions of the black and white keys 1a/1b through the plungers 12 as by step S3.

The central processing unit 21 fetches the pieces of key position data, which are reported to the controller 20 through the key position signals KP, from the signal interface 26, and transfers the pieces of key position data to the random access memory 23 so as to memorize the pieces of key position data therein together with the key number respectively assigned the black and white keys 1a/1b as by step S10. Thus, the values of the maximum keystroke and key number are stored in the random access memory 23 for all the black and white keys 1a/1b.

Subsequently, the central processing unit 20 compares the pieces of key position data with one another to see what key 1a/1b is farthest from the rest position in each of the higher, middle and lower registers as by step S11.

The central processing unit 20 specifies three keys 1a/1b in the individual registers, and determines the values of the maximum keystroke. The central processing unit 20 produces pieces of key position data expressing the values of the maximum keystroke and pieces of image data expressing the register names, and transfers the pieces of key position data and pieces of image data to the display window 24 as by step S12. The display window 24 produces visual images on the basis of the pieces of key position data and pieces of image data. The central processing unit 20 measures 100 milliseconds as by step S13, and returns to step S10 upon expiry of the time period.

Thus, the central processing unit 20 reiterates the loop consisting of steps S10 to S13 for renewing the maximum keystroke, and notices the worker of the maximum keystroke through the display window 24.

When all the actuator holders 100 are lifted at step S3, the worker checks the display window 24 for the maximum keystroke as by step S4. Since the worker has pushed the black and white keys 1a/1b with the plungers 12 at the retracted positions, all the black and white keys 1a/1b are found on the way from the rest positions to the end positions, and the finite values are produced on the display window 24 for all the registers.

The worker selectively drives out the bolts 13 so that the actuator holder or holders 100 are pulled down as by step S5. The worker may pull down the actuator holder by the distance (the value of maximum keystroke+alpha). Alpha is an extremely small amount of keystroke determined by the worker through his or her experience. Then, all the plungers 12 have the top surfaces in the proximity of the lower surfaces of the black and white keys 1a/1b.

FIG. 4C shows the visual images on the display window 24. The display window 24 informs the worker that the maximum keystroke is 0.00 millimeter in the lower register, 1.3 millimeters in the middle register and 2.9 millimeters in the higher register. Although solenoid-operated key actuators 10 for the black/white keys 1a/1b in the lower register are almost optimized, the worker has to further pull down the actuator holders 100 for the middle and higher registers.

As will be understood from the foregoing description, the controller 20 and key sensors 8 notify the worker of the current status of the key actuators 10, and the worker easily adjusts the key actuators 10 to the optimum relative position with respect to the black and white keys 1a/1b by means of the adjusting mechanism 330a with the assistance of the electronic system 300.

In this instance, the controller 20 produces the visual images indicative of the values of the maximum keystroke so that the worker can calculate the distance from the current position to the optimum position for each actuator holder 100. Thus, the adjuster 330 makes the adjusting work speedy.

### Second Embodiment

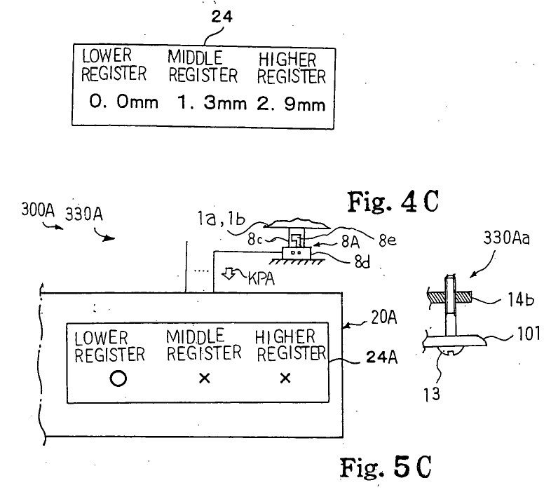

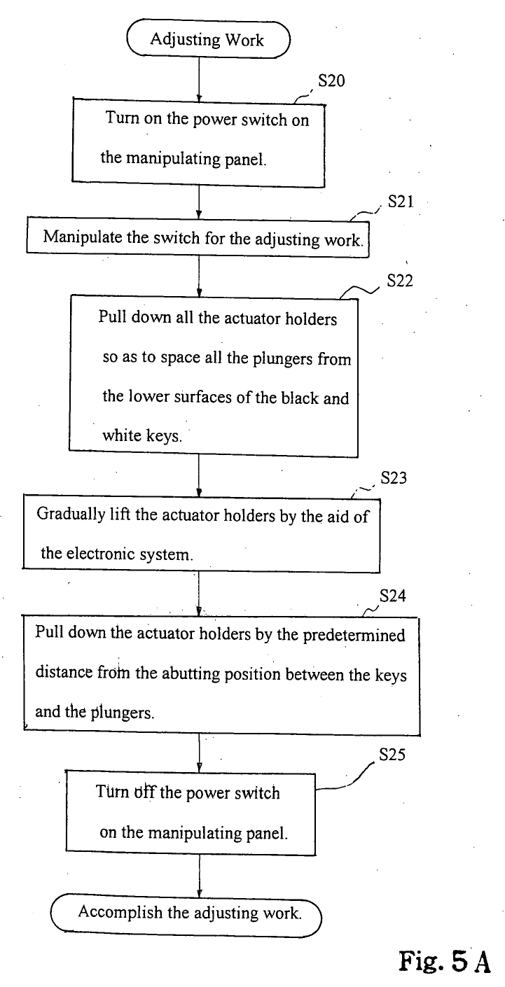

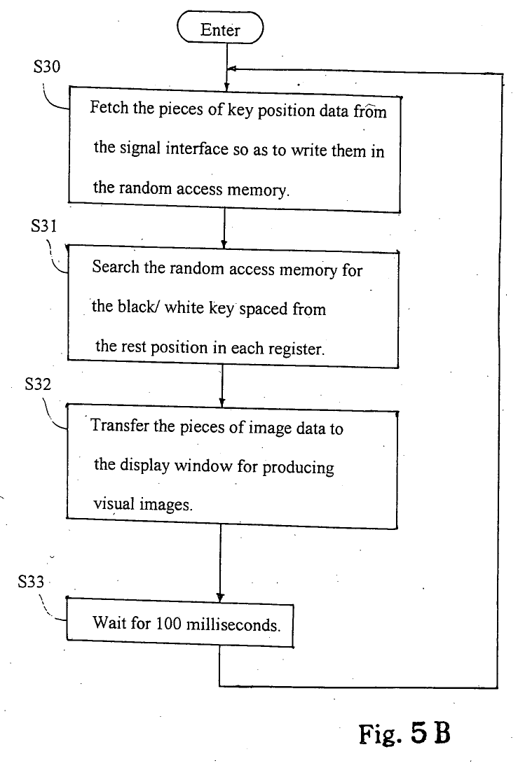

Another automatic player piano embodying the present invention is similar to the automatic player piano shown in FIG. 1 except for a subroutine program for an adjusting work, and the adjusting work and subroutine program for the adjusting work are shown in FIGS. 5A and 5B.

The automatic player piano implementing the second embodiment also largely comprises an acoustic piano and an electronic system 300A, and component parts of the acoustic piano are hereinafter labeled with references designating corresponding component parts of the automatic player piano shown in FIGS. 1 to 3.

An automatic player and a recorder of the electronic system 300A behave as similar to those of the electronic system 300. An adjuster 330Aa includes an array of key sensors 8A, a controller 20A and an adjusting mechanism 330Aa as shown in FIG. 5C. The adjusting mechanism 330Aa is same as the adjusting mechanism 330A so that description on the adjusting mechanism 330Aa is omitted from the following description for the sake of simplicity.

The key sensors 8A are respectively associated with the black and white keys 1a/1b, and are similar in structure to one another. Each of the key sensors 8A is implemented by a combination between a shutter plate 8c and two pairs of sensor heads 8d or photo-couplers. A window 8e is formed in the shutter plate 8c, and is abruptly reduced in width like a step. The shutter plate 8c is secured to the lower surface of the associated black/white key 1a/1b, and the plural pairs of sensor heads 8d throw light beams across the trajectory of the shutter plate 8c. While the black and white keys 1a/1b are staying at the rest positions, both light beams are interrupted with the lower end portions of the shutter plate 8c. When the black/white key 1a/1b leaves the rest position, the window 8e immediately permits one of the light beams to pass the window 8e, and the two-bit key position signal KP is changed. Thus, the controller 20A acknowledges that the black and white key 1a/1b starts the key motion through the change of the bit pattern from [00] to [10]. Thus, the shutter plate 8c is designed in such a manner as to change the bit pattern at predetermined timing.

The controller 20A is similar in system configuration to the controller 20, and a computer program used therein is also broken down into a main routine program and subroutine programs. Only the subroutine program for the adjusting work is different from that of the first embodiment. For this reason, description is focused on the adjusting work and subroutine program for the adjusting work.

A worker is assumed to start the adjusting work on the solenoid-operated key actuators to a proper relative position. Worker firstly turns on the power switch on the manipulating panel as by step S20 as shown in FIG. 5A. The electronic system 300A is energized, and the central processing unit initializes the electronic system 300A. Subsequently, the worker manipulates the switch for the adjusting work on the manipulating panel as by step S21. Then, the main routine program starts to periodically branch the subroutine program for the adjusting work. Thus, the adjuster 330A gets ready to assist the worker.

The worker drives out the bolts 13 from the lower flanges 14b, and makes the gap between the flanges 101 and the lower flanges 14b wider. Then, the actuator holders 100 are lowered, and all of the plungers 12 are spaced from the lower surfaces of the rear portions of the black and white keys 1a/1b as by step S22. In this situation, all the black and white keys 1a/1b are found at the rest positions, and all the key sensors 8A supply the two-bit key position signals [00] to the signal interface.

Upon entry into the subroutine program for the adjusting work, the central processing unit fetches the pieces of key position data expressed by the two-bit key position signals KP from the signal interface, and transfers the pieces of key position data together with the key number assigned the black and white keys 1a/1b to the random access memory so as to write them therein as by step S30 in FIG. 5B.

Subsequently, the central processing unit searches the random access memory for a black/white key having already left the rest position as by step S31. As described hereinbefore, all the plungers 12 have been spaced from the lower surfaces of the black and white keys 1a/1b so that all the black and white keys 1a and 1b are found at the rest positions. Then, the central processing unit supplies pieces of control data expressing “improper relative position” to the display window 24A as by step S32. Visual images “X”, which expresses the improper relative position, are produced on the display window 24A. The central processing unit waits for 100 milliseconds as by step S33, and returns to step S30. Thus, the central processing unit reiterates the loop consisting of steps S30 to S33. Of course, the central processing unit returns to the main routine program after the execution for a predetermined time period, and enters the subroutine program at the next timer interruption.

The worker confirms that all the plungers 12 have been spaced from the black and white keys 1a/1b, and drives in the bolts 13 so as to lift the actuator holders 100 as by step S23. The actuator holder 100 for the lower register is assumed to reach around the proper relative position. The worker further drives in the bolts so that the black/white keys 1a/1b are slightly pushed upwardly with the plungers 12. Then, the two-bit key position signals KP change the bit pattern from [00] to [10]. In this situation, the central processing unit acknowledges that the solenoid-operated key actuators 10 for the lower register are located at the proper relative position. Then, the central processing unit changes the piece of image data from “X” to “◯”, and keeps the other pieces of image data at “X”. For this reason, the visual images “◯” and “X” are produced on the display window 24A as shown in FIG. 5C.

The worker fishes the adjusting work on the actuator holder 100 for the lower register. However, the worker continues to drive in the bolts 13 into the lower flanges 14b for the actuator holders 100 assigned the middle and higher registers. When all the visual images are changed from “X” to “◯”, the worker proceeds to step S24.

The worker slightly drives out the bolts 13 from the lower flanges 14b so that the black and white keys 1a/1b are not pushed with the plungers 12 as by step S24. However, the actuator holders 100 keep the plungers 12 in the close proximity of the lower surfaces of the black and white keys 1a/1b. Then, the solenoid-operated key actuators 10 are adjusted to the proper relative positions with respect to the black and white keys 1a/1b.

When the worker confirms the entry into the proper relative positions, he or she turns off the power switch as by step S25.

The adjuster 330A achieves all the advantages of the first embodiment. Moreover, the key sensors 8A are simpler than the key sensors 8, and the analog-to-digital converters are not required for the key sensors 8A. As a result, the production cost is reduced by virtue of the simple constitution.

### Third Embodiment

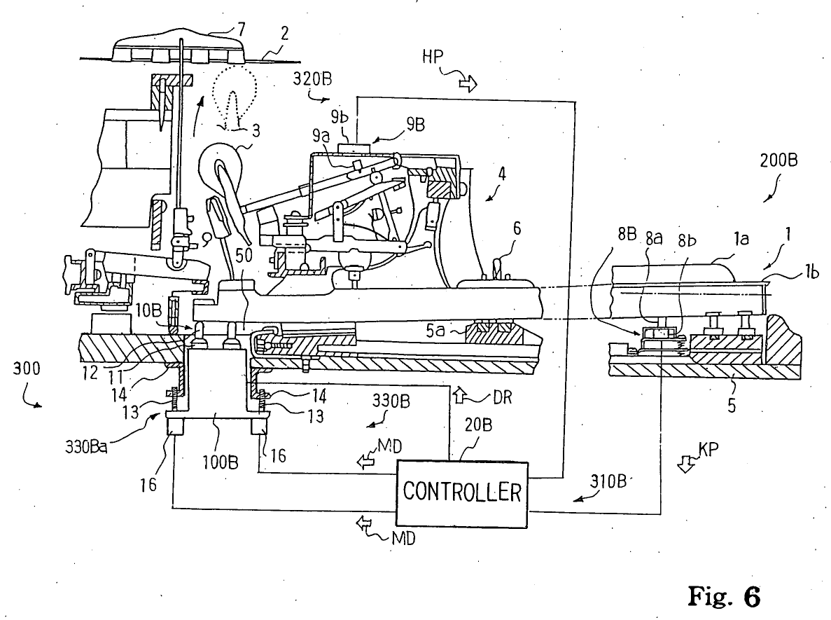

FIG. 6 shows yet another automatic player piano embodying the present invention. The automatic player piano implementing the third embodiment also largely comprises an acoustic piano 200B and an electronic system 300B. Since the acoustic piano 200B is similar in structure to the acoustic piano 200, component parts of the acoustic piano 200B are labeled with reference numerals designating the corresponding component parts of the acoustic piano 200.

The electronic system 300B includes a controller 20B, key sensors 8B, hammer sensors 9B, solenoid-operated key actuators 10B and electric motors 16, and serves as an automatic player 310B, a recorder 320B and an adjuster 330B. The key sensors 8B and hammer sensors 9B are same as the key sensors 8 and hammer sensors 9 so that the component parts are labeled with references designating the corresponding component parts of the key and hammer sensors 8 and 9 without detailed description. Since the automatic player 310B and recorder 320B are similar to the automatic player 310 and recorder 320, description is focused on the adjuster 330B.

The adjuster 320B includes the key sensors 8B, controller 20B, electric motors 16 and an adjusting mechanism 100B. The adjusting mechanism 100B is similar in structure to the adjusting mechanism 100 so that component parts are labeled with reference numerals designating the corresponding component parts of the adjusting mechanism 100 without detailed description. Comparing FIG. 6 with FIG. 1, it is understood that the electric motors 16 are newly added to the adjuster 320B. The electric motors 16 are respectively coupled to the head portions of the bolts 13, and the controller 20B selectively supplies a driving signal MD to the electric motors 16. Standard miniature electric motors serve as the electric motors 16. The electric motors 16 may be of the type that the rotating angle is controllable. A stepping motor is available for the purpose.

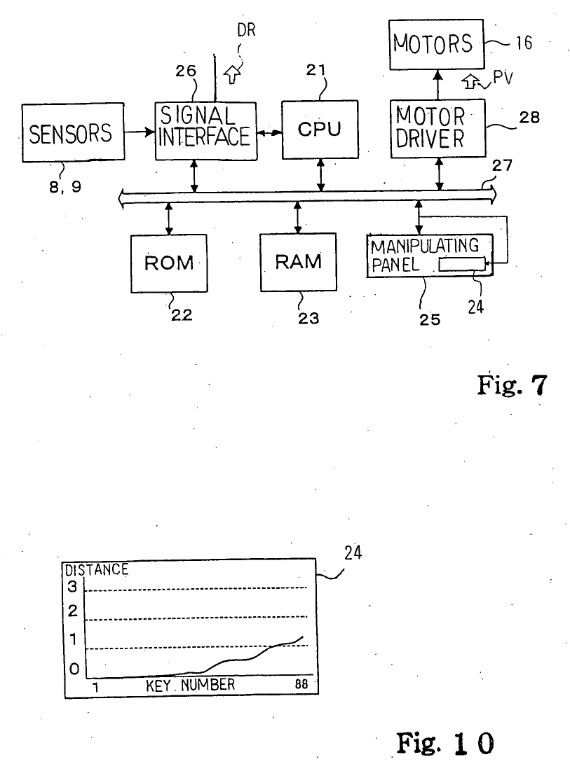

FIG. 7 shows the system configuration of the controller 20B. The system configuration of controller 20B is similar to that of the controller 20 except for a motor driver 28 so that system components are labeled with reference numerals designating the corresponding system components of the controller 20 without detailed description.

The electric motors 16 are selectively energized by means of the motor driver 28. The central processing unit 21 transfers a control code representative of the power-on to the motor driver 28, and makes the motor driver 28 start to energize the electric motors 16 with power voltage PV. On the other hand, when the electric power is to be removed from the electric motors 16, the central processing unit 21 instructs the motor driver 28 through another control code representative of the power-off. In case where the stepping motors are employed in the adjuster 330B, a pulse train is selectively supplied from the motor driver 28 to the electric motors 16.

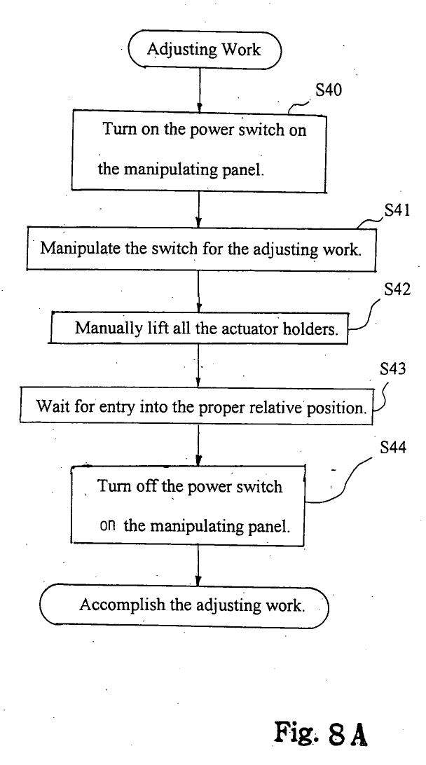

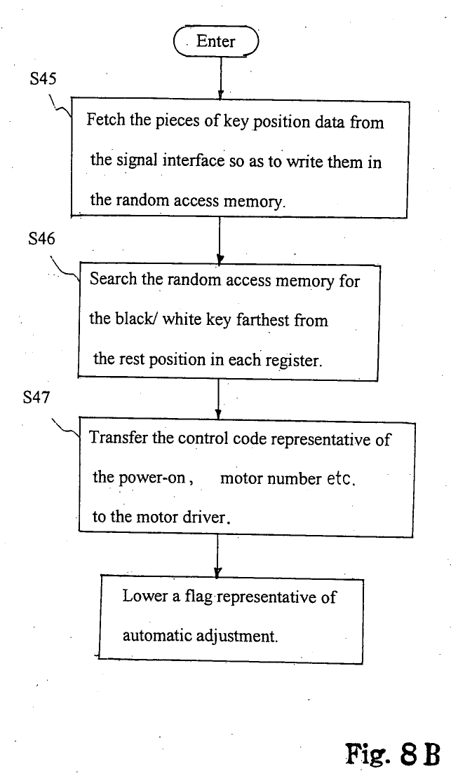

A human worker is assumed to install the solenoid-operated key actuators 10B in the acoustic piano 200B. The brackets 14 have been secured to the key bed 5 at the proper positions, and the solenoid-operated key actuators 10B are selectively held in the three actuator holders 100B. A job sequence shown in FIG. 8A is carried out by the worker, and a job sequence shown in FIG. 8B is accomplished through the data processing by the controller 20B.

The worker firstly turns on the power switch on the manipulating panel 25 as by step S40. Then, the central processing unit 21 initializes the electric system 300B, and the main routine program starts to run on the central processing unit 21. Subsequently, the worker manipulates the switch for the adjusting work as by step S41. Then, the central processing unit 21 raises a flag representative of the automatic adjusting work, and the main routine program gets ready to branch to the subroutine program for the adjusting work. In this situation, the actuator holders 100B are not coupled to the brackets 14.

The worker inserts the bolts 13 into the elongated holes of one of the actuator holders 10B, and drives the bolts 13 into the lower flanges of the brackets 14. The worker further couples the other actuator holders 100B to the brackets 14 in the similar manner. The worker further drives the bolts 13 into the brackets 14 so as to push up the rear portions of the black and white keys 1a/1b with the plungers 12. Thus, the worker lifts all the actuator holders 100B as by step S42. The worker instructs the controller 20B to start to execute the subroutine program for the automatic adjusting work through the manipulating panel 25.

The main routine program starts periodically to branch to the subroutine program for the automatic adjusting work, and the worker stands idle until the automatic adjusting work is accomplished as by step S43.

First, the central processing unit 21 fetches the pieces of key position data from the signal interface 26, and writes the pieces of key position data and key number in the random access memory 23 as by step S45. Each of the pieces of key position data is paired with the key number in the random access memory 23.

Subsequently, the central processing unit 21 searches the random access memory 23 for the black/white key 1a/1b farthest from the rest position in each register as by step S46. When the central processing unit 21 finds a black/white key 1a/1b to be farthest from the rest position in each register, the central processing unit 21 determines the register to which the black/white key 1a/1b belongs, and produces a control code representative of the electric motors to be driven and angle over which the electric motors 16 rotates the bolts 13. The central processing unit 21 produces the control codes for the black/white keys 1a/1b in the other registers. The angle is equivalent to the distance over which the actuator holder 100B is to be pulled down. The distance is equal to the keystroke from the rest position plus alpha. Alpha is an extremely small value so that the top surfaces of the plungers 12 rest in the close proximity of the lower surfaces of the black and white keys 1a/1b.

The central processing unit 21 transfers the control codes to the motor driver 28 as by step S47. The motor driver 28 analyzes the control codes, and energizes the electric motors 16. The electric motors 16 turn over the values of the angle specified by the central processing unit 21 so that each of the actuator holders 100B is pulled down by the predetermined values of the distance. As a result, the solenoid-operated key actuators 10B are located at the proper relative positions to the associated black and white keys 1a/1b.

Upon completion of the jobs at step S47, the central processing unit 21 lowers the flag representative of the automatic adjusting work. Thus, the adjuster 330B automatically brings the solenoid-operated key actuators 10B to the proper relative position with respect to the black and white keys 1a/1b.

When the worker finds the solenoid-operated key actuators 10B at the proper relative position, the worker turns off the power switch on the manipulating panel 25 as by step S44, and accomplishes the adjusting work.

As will be understood from the foregoing description, the controller 20B automatically locates the solenoid-operated key actuators 10B at the proper relative position with respect to the black and white keys 1a/1b so that the worker is expected to carry out only the preparation work. Thus, the adjuster 330B makes the adjusting work easy and speedy.

### Fourth Embodiment

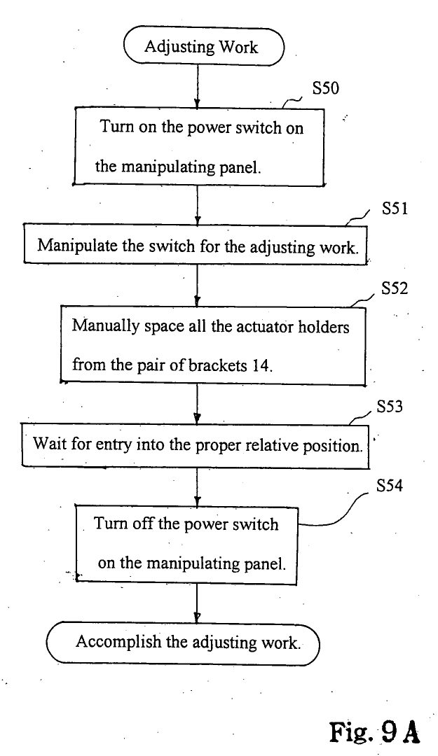

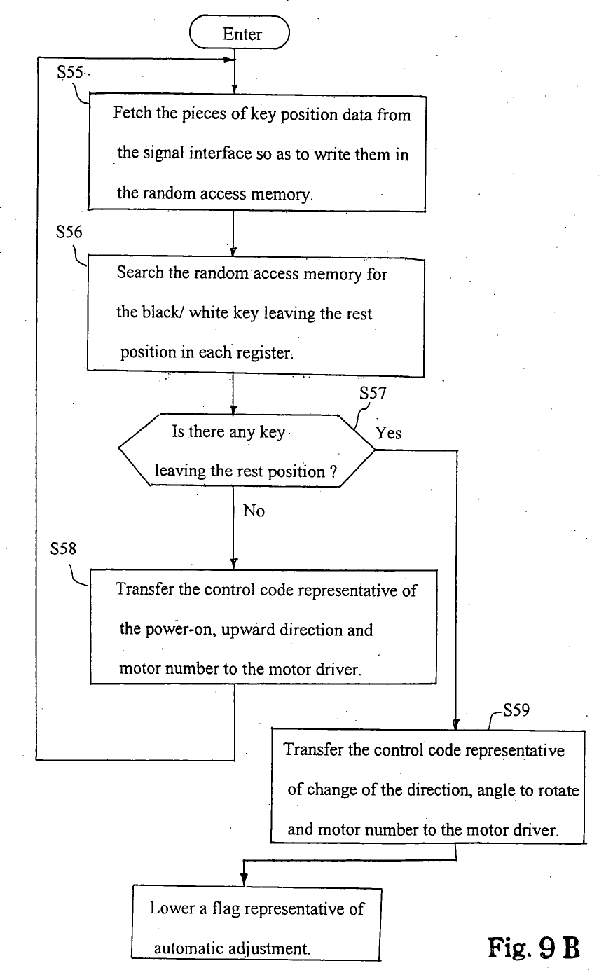

Still another automatic player piano is different from the automatic player piano shown in FIGS. 6 and 7 in that the key sensors 8 are replaced with the key sensors 8A shown in FIG. 5C. For this reason, the references in FIGS. 6 and 7 are used in the following description except for the key sensors 8A. Job sequences are illustrated in FIGS. 9A and 9B.

A worker is assumed to install the solenoid-operated key actuators 10B in the acoustic piano 200B. The brackets 14 have been secured to the key bed 5 at the proper positions, and the solenoid-operated key actuators 10B are selectively held in the three actuator holders 100B. The job sequence shown in FIG. 9A is carried out by the worker, and the job sequence shown in FIG. 9B is accomplished through the data processing by the controller 20B.

The worker firstly turns on the power switch on the manipulating panel 25 as by step S50. Then, the central processing unit 21 initializes the electric system 300B, and the main routine program starts to run on the central processing unit 21. Subsequently, the worker manipulates the switch for the adjusting work as by step S51. Then, the central processing unit 21 raises a flag representative of the automatic adjusting work, and the main routine program gets ready to branch to the subroutine program for the adjusting work. In this situation, the actuator holders 100B are not coupled to the brackets 14.

The worker inserts the bolts 13 into the elongated holes of one of the actuator holders 100B, and drives the bolts 13 into the lower flanges of the brackets 14. The worker further couples the other actuator holders 100B to the brackets 14 in the similar manner. However, the worker keeps the bolts 13 loosened. Thus, the worker spaces the top surfaces of the plungers 12 from the lower surfaces of the black and white keys 1a/1b as by step S52.

The worker instructs the controller 20B to start to execute the subroutine program for the automatic adjusting work through the manipulating panel 25. The main routine program starts periodically to branch to the subroutine program for the automatic adjusting work, and the worker stands idle until the automatic adjusting work is accomplished as by step S53.

First, the central processing unit 21 fetches the pieces of key position data from the signal interface 26, and writes the pieces of key position data and key number in the random access memory 23 as by step S55. Each of the pieces of key position data is paired with the key number in the random access memory 23.

Subsequently, the central processing unit 21 searches the random access memory 23 for the black/white key 1a/1b already left the rest position in each register as by step S56. The central processing unit 21 makes a decision on the question as by step S57. If there is not found any black/white key 1a/1b, the answer is given negative “No”. Then, the central processing unit 21 produces a control data code representative of the power-on, direction in which the actuator holders 100B are moved, i.e., upward direction and electric motors 16 to be driven for rotation, and transfers the control code to the motor driver 28 as by step S58. Since all the solenoid-operated key actuators 10B are spaced from the associated black and white keys 1a/1b, all of the electric motors 16 are to be rotated.

The motor driver 28 energizes all the electric motors 16 so that the electric motors 16 are driven to rotate the bolts 13. As a result, the actuator holders 100B are lifted toward the black and white keys 1a/1b by predetermined distance.

When the central processing unit 21 transfers the control code to the motor driver 28, it returns to step S55. Thus, the central processing unit 21 reiterates the loop consisting of steps S55 to S58 until the answer at step S57 is changed to affirmative “yes” so that the actuator holders 100B are stepwise lifted toward the black and white keys 1a/1b.

When the plunger 12 is brought into contact with the lower surface of a black/white key 1a/1b, the central processing unit 21 finds the black/white key 1a/1b leaving the rest position, and the answer is changed affirmative “yes”. The central processing unit 21 determines the register to which the black/white key 1a/1b belongs, and produces a control code representative of the electric motors to be driven in the opposite direction and angle over which the electric motors 16 rotates the bolts 13. If the central processing unit 21 finds a black/white key 1a/1b in another register or keys 1a/1b in the other registers, the central processing unit 21 also produces the control codes for the black/white key or keys 1a/1b in the other registers.

The central processing unit 21 transfers the control code or codes to the motor driver 28 as by step S59. The motor driver 28 analyzes the control codes, and changes the polarization so as to change the rotation to the opposite direction. The electric motors 16 turn over the values of the angle specified by the central processing unit 21 so that the actuator holder or holders 100B are pulled down by the predetermined values of the distance. As a result, the top surfaces of the solenoid-operated key actuators 10B are brought into proximity of the lower surfaces of the black and white keys 1a/1b. Thus, the solenoid-operated key actuators 10B are located at the proper relative positions to the associated black and white keys 1a/1b.

Upon completion of the jobs at step S59, the central processing unit 21 lowers the flag representative of the automatic adjusting work. Thus, the adjuster 330B automatically brings the solenoid-operated key actuators 10B to the proper relative position with respect to the black and white keys 1a/1b.

When the worker finds the solenoid-operated key actuators 10B at the proper relative position, the worker turns off the power switch on the manipulating panel 25 as by step S54, and accomplishes the adjusting work.

Thus, the adjuster achieves all the advantages of the third embodiment. Moreover, the key sensors 8A are lower in price than the key sensors 8 so that the production cost is reduced.

Although particular embodiments of the present invention have been shown and described, it will be apparent to those skilled in the art that various changes and modifications may be made without departing from the spirit and scope of the present invention.

In case the automatic player piano is fabricated on the basis of a standard grand piano, alpha ranges from 0.5 millimeter to 1.0 millimeter.

The optical key sensors 8 and optical hammer sensors 9 do not set any limit to the technical scope of the present invention. A piece of magnet and a Hall element may serve as a key sensor or a hammer sensor.

It is possible to replace the hammer sensors 9 with a different type of optical sensors. The optical sensor may be implemented by a combination between a photo-coupler and a shutter plate. The shutter plate is attached to the hammer shank, and is formed with a window. The window is adjusted to a predetermined value of width, and the photo-coupler throws a light beam across the trajectory of the shutter plate. The window permits the light beam to pass therethrough immediately before the collision with the string 2, and the shutter plate intersects the light beam, again, at the timing to give the impact at the string 2. The hammer velocity is calculated on the basis of the lapse of time and the predetermined value of width.

The controller 20 may produce a visual images indicative of the relative position between each of the black/white keys 1a/1b and the associated black/white key 1a/1b as shown in FIG. 10.

Each of the actuator holders 100, 100A or 100B may be connected to a bracket, which is secured to the key bed 5, by means of three bolts, and the controller 20, 20A or 20B selectively drives the three bolts so as to three-dimensionally change the attitude of the actuator holder 100, 100A or 100B. The actuator holders 100, 100A or 100B may be less than or greater than three.

The controller 20 may assist a worker in the adjusting work through voice messages, sound or indicators radiating light different in color. In other words, the controller 20 may have a speaker system, buzzer or lamps instead of or together with the display window 24.

The hammer sensors 9 or key sensors 8 may be deleted from the automatic player piano of the present invention. In case where the key sensors 8 are deleted from the electronic system, the controller determines the current key positions on the basis of the hammer stroke, because the black and white keys 1a/1b, which are found on the key trajectories between the rest positions and the escape points, force the hammers 3 to rotate. Thus, the key sensors 8 do not set any limit to the technical scope of the present invention. The controller can determine the relative position between the key actuators and the black/white keys 1a/1b on the basis of the motion of any component parts in so far as the component parts are linked with the black and white keys 1a/1b.

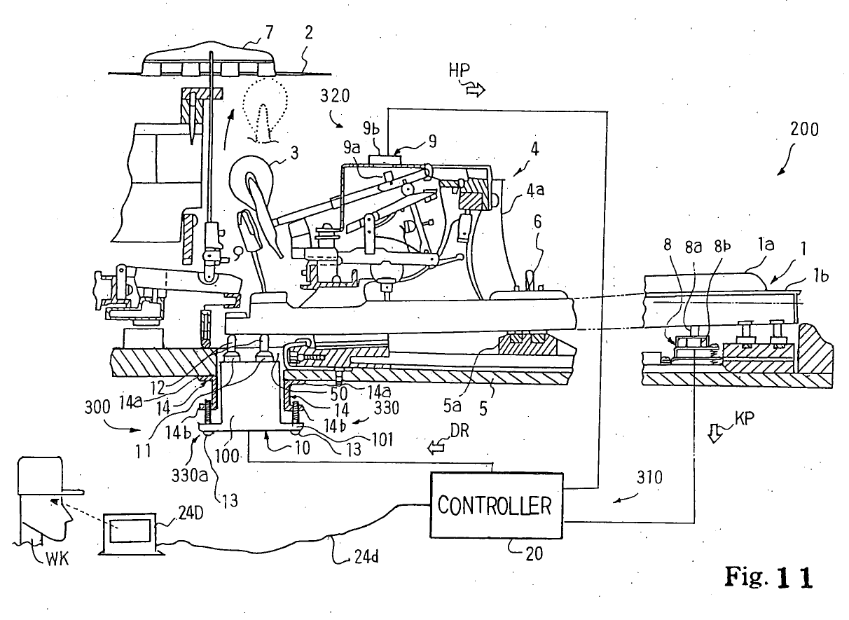

Au auxiliary display panel 24D may be further provided for a worker WK as shown in FIG. 11. The auxiliary display panel 24D is connected to the controller 20 through a long cable 24d, and the worker WK carries the auxiliary display panel 24D beside him or her before the adjusting work.

The constitutions of the adjusting mechanisms 330a, 330Aa and 330Ba do not set any limit to the technical scope of the present invention. The bolts 13 and male screws formed in the lower flanges 14b may be replaced with a combination between a pinion and rack, any other mechanism to convert rotation to linear motion or a pusher such as, for example, a hydraulic linear actuator or a pneumatic linear actuator. A pair of wedges is also available for the adjusting mechanism. The solenoid-operated key actuators or actuator holders are mounted on one of the wedges, and another wedge advances so as to push up the solenoid-operated key actuators or actuator holders.

The electric motors 16 do not set any limit to the technical scope of the present invention. A hydraulic motor or a pneumatic motor may be connected to the bolts 13. In case where the pneumatic motor or hydraulic motor is employed, a suitable compressor or an oil pump is incorporated in the motor driver 28 together with control valves.

The solenoid-operated key actuators 10, 10A and 10B do not set any limit to the technical scope of the present invention. Any sort of converter, which converts energy to mechanical motion, is available for the automatic player. For example, hydraulic actuators, pneumatic actuators, linear motors or voice coil motors may be used to drive the black and white keys 1a/1b.

The adjuster 330 of the present invention may further carry out the automatic adjusting work, and the adjuster 330B may further notice the worker of the current status between the solenoid-operated key actuators and the black and white keys 1a/1b.

The controller 20 or 20A may express the current status between the solenoid-operated key actuators 10/10B and the black and white keys 1a/1b through a length driven into the brackets 14 or the thickness of the wedge.

Sensors may be exclusively used in the adjusting work. In other words, the sensors for the adjusting work may be newly installed.

The adjuster 330, 330A or 330B may be separated from the electronic system 300, 300A or 330B. In other words, a portable adjuster may be prepared in accordance with the present invention.

The grand pianos 200 and 200B do not set any limit to the technical scope of the present invention. An automatic player piano may be fabricated on the basis of an upright piano. The electric system 300, 300A or 300B may be installed in another sort of musical instrument such as, for example, an electronic piano, a harpsichord, an organ or a percussion instrument such as a celesta.

A mute system may be further installed in the automatic player piano. The mute system includes a hammer stopper changed between a free position and a blocking position. While the hammer stopper is staying at the free position, the hammers are brought into collision with the strings without any interruption of the hammer stopper so that the acoustic piano tones are produced through the vibrations of the strings. When the hammer stopper is changed to the blocking position, the hammer stopper enters the trajectories of the hammers, and causes the hammers to rebound thereon before striking the strings. Any acoustic piano tone is not produced. Instead, the key sensors and hammer sensors monitor the keys and hammers, and the controller produces music data codes representative of the electronic tones to be produced so that the electronic tones are produced through a headphone.

The component parts of the automatic player pianos are correlated with claim languages as follows. The key sensors 8 or 8A or hammer sensors 9 serve as “sensors”, and the black and white keys 1a/1b are corresponding to “component parts”. The key sensors 8 or 8A directly monitor the black and white keys 1a/1b. However, the hammer sensors 9 indirectly monitor the black and white keys 1a/1b. The key position signals KP or hammer position signals HP are corresponding to “a status signal”, and “current status” is indicative of the keystroke or hammer stroke. The pieces of image data and driving signals MD are corresponding to “an information signal”.

The solenoid-operated key actuators 10, 10A and 10B serve as “actuators”, and the driving signals DR are equivalent to “a driving signal”. The black and white keys 1a/1b, strings 2, hammers 3, action units 4 and dampers 7 as a whole constitute “a sound generating mechanism”.

“Relative positions” are spaced from the lower surfaces of the black and white keys 1a/1b by alpha, and the lower surfaces are found at “reference positions” when the black and white keys 1a/1b are found at the rest positions. The electric motors 16 serve as “other actuators”.

What is claimed is:

1. An adjuster for adjusting actuators to respective relative position with respect to component parts of a musical instrument, comprising:
sensors producing a status signal representative of current status of said component parts; and
a controller connected to said sensors, and producing an information signal representative of deviation between said current status and said relative positions so as to aid an adjusting work on said actuators.

2. The adjuster as set forth in claim 1, in which said sensors directly monitor said component parts for producing said status signal.

3. The adjuster as set forth in claim 2, in which each of said sensors has a detectable range where an entire trajectory of associated one of said component parts is fallen.

4. The adjuster as set forth in claim 3, in which said each of said sensors produces the status signal indicative of a distance between a current position of said associated one of said component parts on said entire trajectory and a reference position in the proximity of the relative position as said current status.

5. The adjuster as set forth in claim 4, in which said controller causes a display panel to produce visual images representative of said distance as said deviation.

6. The adjuster as set forth in claim 4, in which said controller supplies said information signal to other actuators for moving said actuators in a direction toward said component parts and vice versa so that said other actuators bring said actuators to said relative positions.

7. The adjuster as set forth in claim 2, in which said sensors produces said status signal when said component parts are found at respective reference positions in the proximity of said relative positions.

8. The adjuster as set forth in claim 7, in which said controller produces said information signal representative of said current status out of said reference points for the component parts not found at said reference positions and said information signal representative of said current status at said reference positions for the component parts found at said reference positions.

9. The adjuster as set forth in claim 8, in which said information signal causes a display panel to produce visual images of symbols representative of said current status out of said reference positions and said current status at said reference positions.

10. The adjuster as set forth in claim 8, in which said controller supplies said information signal to other actuators for moving said actuators in a direction toward said component parts and vice versa so that said other actuators bring said actuators through said reference positions to said relative positions.

11. An automatic player for automatically producing music sound through a musical instrument, comprising:
actuators proved in association with component parts of said musical instrument, and responsive to a driving signal so as selectively to give rise to motion of said component parts for producing said music sound; and
an adjuster for adjusting said actuators to respective relative positions with respect to said component parts, and including
sensors producing a status signal representative of current status of said component parts and
a controller connected to said actuators for supplying said driving signal thereto and to said sensors for receiving said status signal and producing an information signal representative of deviation between said current status and said relative positions so as to aid an adjusting work on said actuators.

12. The automatic player as set forth in claim 11, in which said controller further determines a deviation between said current status and target status expressed by pieces of music data so as to adjust a magnitude of said driving signal to an optimum value, which makes said deviation minimized.

13. The automatic player as set forth in claim 11, in which said adjuster further includes a display panel supplied with said information signal so that visual images expressing said deviation is produced on said display panel.

14. The automatic player as set forth in claim 11, in which said adjuster further includes other actuators for moving said actuators in a direction toward said component parts and vice versa so that said controller drives said other actuators with said information signal.

15. The automatic player as set forth in claim 1, in which said component parts are divided into plural groups so that said information signal has plural information sub-signals representative of the current status of said plural groups.

16. A musical instrument for producing music sound, comprising:
a sound generating mechanism including component parts selectively actuated for producing said music sound;
actuators proved in association with said component parts of said musical instrument, and responsive to a driving signal so as selectively to give rise to motion of said component parts; and
an adjuster for adjusting said actuators to respective relative positions with respect to said component parts, and including
sensors producing a status signal representative of current status of said component parts and
a controller connected to said actuators for supplying said driving signal thereto and to said sensors for receiving said status signal and producing an information signal representative of deviation between said current status and said relative positions so as to aid an adjusting work on said actuators.

17. The musical instrument as set forth in claim 16, in which said component parts are keys depressed and released for specifying the pitch of tones to be produced as said musical sound.

18. The musical instrument as set forth in claim 17, in which said sound generating mechanism further includes action units respectively linked with said keys, hammers driven for rotation by said action units and strings struck with said hammers for producing said tones.

19. The musical instrument as set forth in claim 16, in which said adjuster further includes a display panel supplied with said information signal so that said controller produces visual images representative of said deviation on said display penal.

20. The musical instrument as set forth in claim 16, in which said adjuster further includes other actuators for moving said actuators in a direction toward said component parts and vice versa so that said controller drives said other actuators with said information signal.
